(19) United States
(12) Patent Application Publication
(10) Pub. No.: US 2024/0184305 A1
(43) Pub. Date: Jun. 6, 2024

(54) MOBILE ROBOT FOR DETERMINING WHETHER TO BOARD ELEVATOR, AND OPERATING METHOD THEREFOR

(71) Applicant: HOSEO UNIVERSITY ACADEMIC COOPERATION FOUNDATION, Chungcheongnam-do (KR)

(72) Inventor: Young Eun SONG, Chungcheongnam-do (KR)

(21) Appl. No.: 18/283,259

(22) PCT Filed: Mar. 23, 2022
(86) PCT No.: PCT/KR2022/004081

§ 371 Date: Sep. 21, 2023

(30) Foreign Application Priority Data
Mar. 24, 2021 (KR) 10-2021-0038132

(51) Int. Cl. G05D 1/243; G05D 101/15; G05D 105/28; G05D 107/60; G06V 10/14; G06V 20/58; G06V 40/16; G08B 3/00

(52) U.S. Cl. CPC G05D 1/2435; G06V 10/14; G06V 20/58; G06V 40/166; G05D 2101/15; G05D 2105/28; G05D 2107/60; G08B 3/00

(57) ABSTRACT

A mobile robot for determining whether to board an elevator may include a camera configured for capturing an inside of the elevator, an object recognition unit configured for recognizing an area of the elevator and the number of passengers from an image captured by the camera, and a control unit configured for calculating a density of the elevator based on the area and the number of passengers. The control unit may perform a determination of whether to board the elevator based on the density, and control a driving wheel motor based on the determination.

### CROSS REFERENCE TO RELATED APPLICATIONS AND CLAIM OF PRIORITY

This application claims benefit under 35 U.S.C. 119, 120, 121, or 365 (c), and is a National Stage entry from International Application No. PCT/KR2022/004081, filed Mar. 23, 2022, which claims priority to the benefit of Korean Patent Application No. 10-2021-0038132 filed in the Korean Intellectual Property Office on Mar. 24, 2021, the entire contents of which are incorporated herein by reference.

### BACKGROUND

### 1. Technical Field

The present invention relates to boarding of an elevator by a mobile robot and, more specifically, to a mobile robot and an operating method therefor, the mobile robot determining whether to board an elevator so that boarding of the elevator is possible even if somewhat difficult when the mobile robot delivers emergency goods.

### 2. Background Art

In general, autonomous driving vehicles (automated guided vehicles (AGVs)) or autonomous mobile robots are often used for logistics movement indoors or in factories. In particular, when a mobile robot moves between floors by taking an elevator in a building, the mobile robot may take a passenger elevator.

In particular, in buildings of hospitals, factories, offices, companies, public organizations, or the like, mobile robots may be loaded with goods that have to be delivered expeditiously and take the elevator with passengers. Examples of the related art include Korean Utility Model Registration No. 20-0232858 (Wheelchair Belt Tire System) and Korean Unexamined Patent Publication No. 10-2009-0103357 (Wheelchair for Climbing Stair and Wheel Thereof).

However, the mobile robots were not capable of determining how many passengers per unit area of the elevator would allow the mobile robot to board the elevator. Moreover, there is no known or studied algorithm for mobile robots to move the passengers closer to each other and board therebetween to quickly deliver emergency goods. Without such an algorithm, unconditional boarding of a mobile robot results in disadvantages of a high risk of safety accidents with passengers and a long delivery time to wait for an empty elevator.

### SUMMARY

Hence, the present invention is conceived to solve the problems described above, and objects to be achieved by the present invention are to provide a mobile robot for determining whether to board an elevator and an operation method therefor, in which the mobile robot determines whether to board the elevator by recognizing an area of an elevator and the number of passengers.

In addition, another object of the present invention is to provide a mobile robot for determining whether to board an elevator and an operation method therefor, in which the mobile robot boards at a low speed by securing a space between passengers who are made to move closer to each other during delivery of emergency goods.

Still another object of the present invention is to provide a mobile robot for determining whether to board an elevator and an operation method therefor, in which the mobile robot has a capability to accurately determine a possibility of boarding by inferring an area of the elevator and the number of passengers from an image captured by a camera by using an inference unit trained by artificial intelligence machine learning.

However, technical objects to be achieved by the present invention are not limited to the technical objects mentioned above, and the following description enables still other unmentioned technical objects to be clearly understood by a person of ordinary skill in the art to which the present invention pertains.

In order to achieve one technical object described above, there is provided a mobile robot for determining whether to board an elevator, the mobile robot 100 including: a camera 120 capturing an inside of the elevator 10; an object recognition unit 194 recognizing an area of the elevator 10 and the number of passengers 20 from an image 90 captured by the camera 120; and a control unit 110 calculating a density of the elevator 10 on the basis of the area and the number of passengers, in which the control unit 110 performs a determination of whether to board the elevator 10 based on the density, and the control unit 110 controls a driving wheel motor 170 based on the determination.

In addition, the camera 120 is a stereo camera.

In addition, the mobile robot further includes an inference unit 196 machine-learned to infer the area of the elevator 10 and the number of passengers 20 from a plurality of images. The object recognition unit 194 counts the number of the passengers 20 based on the inference result and facial recognition of the passengers 20.

In addition, the density is calculated as a percentage of (number of passengers/area).

In addition, the mobile robot further includes at least one of a speaker (184) outputting a guidance audio during boarding the elevator 10; and a display 182 for attracting attention to a boarding motion.

In addition, the mobile robot 100 further includes a loading unit 130 in which a cargo to be delivered is loaded.

Another object of the present invention can be achieved by, as another category, an operating method for the mobile robot for determining whether to board an elevator described above, the operation method including steps in which: (S100) a camera 120 captures the inside of an elevator 10; (S120) an object recognition unit 194 recognizes the area of the elevator 10 and the number of passengers 20 from an image 90 captured by the camera 120; (S140) a control unit 110 calculates the density of the elevator 10 on the basis of the area and the number of passengers, and compares whether the density is less than a threshold; and (S160) the control unit 110 controls a driving wheel motor 170 to allow boarding of the elevator if the density is less than the threshold.

In addition, after the comparing step (S140), in a case where the density is equal to or higher than the threshold, a step (S180) in which the mobile robot waits for another elevator 10 without boarding the elevator 10 is executed.

In addition, when the boarding step (S160) is executed, at least one of a step of outputting a boarding guidance audio to a speaker 184; and a step of emitting light by a display 182 to attract attention for a boarding motion is executed.

In addition, in the boarding step (S160), the mobile robot 100 boards the elevator at a low speed slower than a walking speed of the passengers 20, and stops at a boarding position 80 adjacent to a door of the elevator 10.

In addition, the recognizing step (S120) further includes a step in which the inference unit 196 trained by artificial intelligence infers the area of the elevator 10 and the number of passengers 20 from the image, and the object recognition unit 194 recognizes the area of the elevator 10 and the number of passengers 20 based on the inference result.

According to an embodiment of the present invention, it is possible determine whether to board an elevator by recognizing an area of the elevator and the number of passengers. Hence, it is possible to move quickly between floors by taking the elevator while preventing safety accidents with passengers.

Further, the mobile robot can board the elevator at a low speed by securing space between passengers by moving them closer to each other even if somewhat difficult when a mobile robot loads and delivers emergency goods.

Further, it is possible to determine an accurate possibility of boarding by inferring the area of the elevator and the number of passengers from images captured by a camera by using an inference unit machine-trained with artificial intelligence. Hence, the mobile robot does not need to input information about various shapes and sizes of elevators.

However, effects to be achieved by the present invention are not limited to the effects mentioned above, and the following description enables other unmentioned effects to be clearly understood by a person of ordinary skill in the art to which the present invention pertains.

### BRIEF DESCRIPTION OF THE DRAWINGS

The following drawings accompanied in this specification illustrate a preferred embodiment of the present invention and are provided to cause the technical idea of the present invention to be better understood with the detailed description of the invention to be described below, and thus the present invention is not to be construed by being limited only to illustration of the drawings.

FIG. 1 is a view of an operation state illustrating a state in which a mobile robot determines whether to board an elevator according to an embodiment of the present invention.

FIG. 2 is a schematic block diagram of the mobile robot for determining whether to board the elevator according to the embodiment of the present invention.

FIG. 3 illustrates an example of an image of an elevator.

FIGS. 4 to 7 are plan views illustrating, step by step, a process of boarding the elevator by a mobile robot according to the embodiment of the present invention.

FIG. 8 is a flowchart illustrating an operation method for a mobile robot according to another embodiment of the present invention.

### DETAILED DESCRIPTION

Hereinafter, embodiments of the present invention will be described with reference to the accompanying drawings and in detail to the extent that a person with ordinary knowledge in the art to which the present invention pertains can easily implement the embodiments of the present invention. However, since the description of the present invention is provided for only an embodiment for describing structural or functional description, e of the claims of the present invention is not to be construed as limited by the embodiments described herein. That is, since the embodiment can be variously modified and can have various forms, the scope of the claims of the present invention is to be understood to include equivalents capable of realizing technical ideas. In addition, since objects or effects presented in the present invention do not mean that a specific embodiment is to include all of the objects or the effects or include only the effects, the scope of the claims of the present invention is not to be construed as limited thereby.

Meanings of terms provided herein are to be understood as follows.

Terms such as “first” and “second” are used to distinguish one configurational element from another configurational element, and the scope of the claims is not to be limited by these terms. For example, a first configurational element can be named as a second configurational element, and similarly, the second configurational element can also be named as the first configurational element. The description in which one configurational element is mentioned to be “connected to” another configurational element is to be understood to mean that the one configurational element can be directly connected to the other configurational element, or that still another configurational element can be present therebetween. On the other hand, the description in which one configurational element is “directly connected to” another configurational element is to be understood to mean that no configurational element is present therebetween. Meanwhile, the same is true of other expressions, that is, “between” and “directly between”, “adjacent” and “directly adjacent”, or the like for describing relationships between configurational elements.

An expression with a singular form is construed to include a meaning of a plural form thereof, unless obviously implied otherwise in context. Terms such as “comprise” or “have” are to be construed to specify that a feature, a number, a step, an operation, a configurational element, a member, or a combination thereof described herein is present and are not to exclude presence or a possibility of addition of one or more other features, numbers, steps, operations, configurational elements, members, or combinations thereof in advance.

Unless otherwise defined, all terms used herein have the same meanings as meanings generally understood by a person of ordinary skill in the art to which the present invention pertains. The same terms as those defined in a generally used dictionary are to be construed as having the same meanings as the contextual meanings in the related art. In addition, unless clearly defined in the present invention, the terms are not to be construed as having ideal or excessively formal meanings.

### Configurations of Embodiments

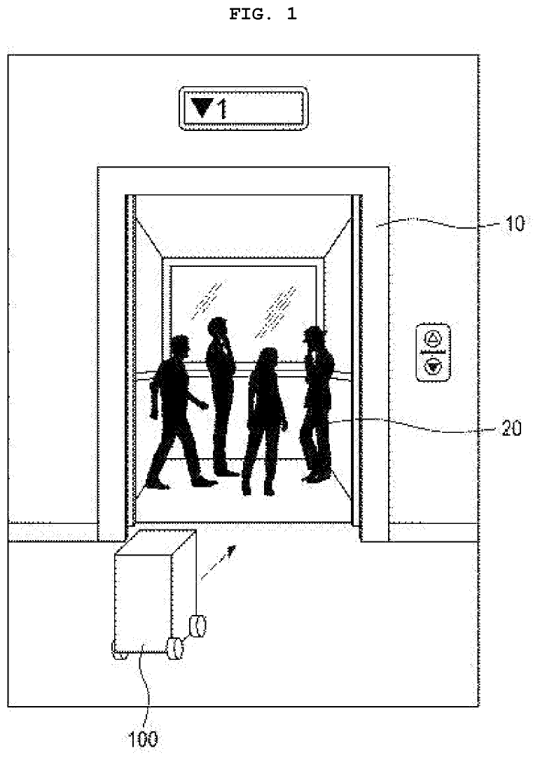

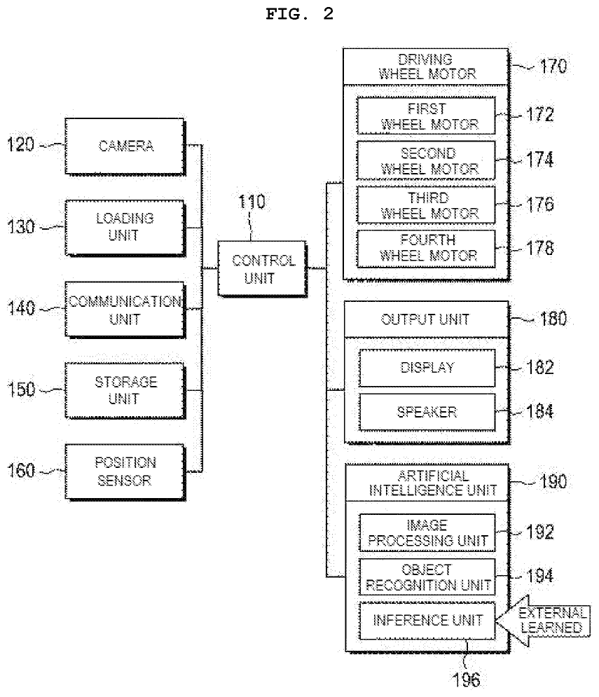

Hereinafter, configurations of preferred embodiments will be described in detail with reference to the accompanying drawings. FIG. 1 is a view of an operation state illustrating a state in which a mobile robot determines whether to board an elevator according to an embodiment of the present invention, and FIG. 2 is a schematic block diagram of the mobile robot for determining whether to board the elevator according to the embodiment of the present invention. As illustrated in FIGS. 1 and 2, a mobile robot 100 includes a driving wheel motor 170 to perform autonomous driving.

The driving wheel motor 170 can be operated at one of a general driving speed (3 to 4 km/h) similar to a walking speed of a pedestrian and a low driving speed (1 to 2 km/h) slower than a usual driving speed. In particular, the low driving speed is used when the mobile robot boards an elevator 10. First, second, third, and fourth driving wheel motors 172, 174, 176, and 178 are mounted to control respective driving wheels. The driving wheel motors are servomotors. The mobile robot 100 is equipped with four driving wheels, but the number of wheels can be further increased or decreased (for example, three) as necessary.

An output unit 180 includes an LCD display 182 configured of a touch screen for displaying information of the mobile robot 100 and a speaker 184 outputting a guide voice or a guide sound. The output unit 180 can include an LED, a warning light, a buzzer, and the like.

The camera 120 is a camera that images a front scene and outputs a digital image 90. The camera 120 can be a stereo camera for three-dimensional recognition or a camera for depth recognition.

A loading unit 130 is a cargo compartment in which a cargo to be delivered is loaded. The loading unit 130 is equipped with a locking device and can have additional refrigeration or freezing equipment as necessary. Emergency goods to be loaded on the loading unit 130 may include blood, a medicine, a sample, a security key, an important document, fresh food, or the like.

A communication unit 140 includes a wireless communication module capable of communicating with an external server device (not illustrated) and may be a Wi-Fi module, a Bluetooth module, a 3G to 5G communication module, a wireless LAN module, a wireless Internet module, a Zigbee module, or the like. Through the communication unit 140, an operation of the mobile robot 100 can be controlled, and a condition of the mobile robot 100 can be transmitted to the outside.

A storage unit 150 stores a program required for an operation of the mobile robot 100 and stores the captured image 90, an operation record, state information, environment setting information, or the like. Examples of the storage unit 150 may include a hard disk, a flash memory, an optical disk, a RAM, a ROM, or the like.

Examples of position sensors 160 include various sensors capable of detecting a position and movement of the mobile robot 100. The position sensor 160 includes a GPS receiver, a gyro sensor, an acceleration sensor, a distance sensor, a lidar, an infrared proximity sensor, and the like.

A control unit 110 performs calculations and determination of the mobile robot 100, executes necessary software, and controls peripheral devices. The control unit 110 can be a CPU or a microcomputer.

An artificial intelligence unit 190 infers an area of the elevator 10 and the number of passengers from the images 90 captured by the camera 120. To this end, an image processing unit 192 extracts a necessary image from the images captured by the camera 120 and deletes a region other than the inside of the elevator. If the camera 120 captures a video, the image processing unit 192 extracts a frame and converts the frame into a specific format (for example, a JPG file).

An inference unit 196 has an internal artificial intelligence model that has machine-learned the area of the elevator 10 and the number of passengers 20. An example of the artificial intelligence model can be a neural network model.

In order for the inference unit 196 to derive an accurate inference result, as many images as possible, images of as various elevators (small, medium, large elevators, cuboidal or cylindrical elevators, and the like) as possible, and images of passengers representing the number of various cases (a case of no passengers, a case of a few passengers, a case of moderate number of passengers, a somewhat dense case, a case of full passengers, and the like) are machined-learned.

The inference unit 196 equipped with the machine-learned artificial intelligence model infers the area of the elevator and the number of passengers from the image 90 transmitted from the image processing unit 192.

An object recognition unit 194 outputs the final number of passengers by using the inference result of the inference unit 196 and the number of passengers counted by an algorithm. The algorithm may include a method of recognizing a passenger through facial recognition of the passenger 20, a method of recognizing a passenger through recognition of a head shape of the passenger 20, a method of recognizing a passenger by extracting an outline of a passenger image, or the like. The object recognition unit 194 averages the number of passengers inferred by the inference unit 196 and the number of passengers calculated by the algorithm and recognizes the obtained average as the final number of passengers. Optionally, the object recognition unit 194 may refer only to the inference unit 196 or utilize only the algorithm.

### Operations of Embodiments

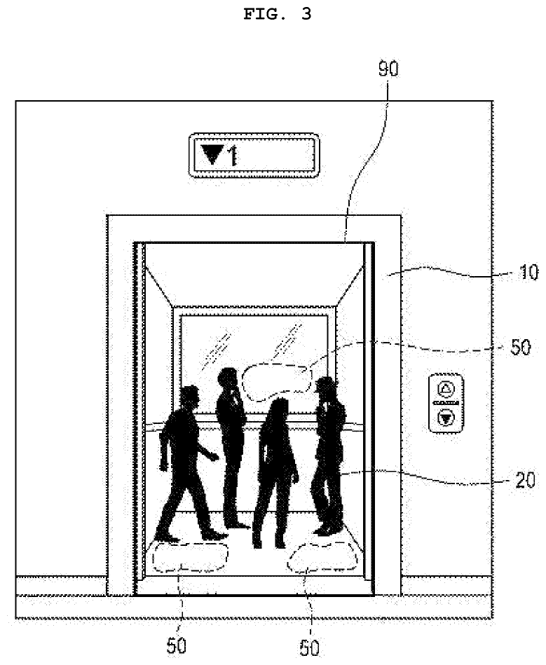

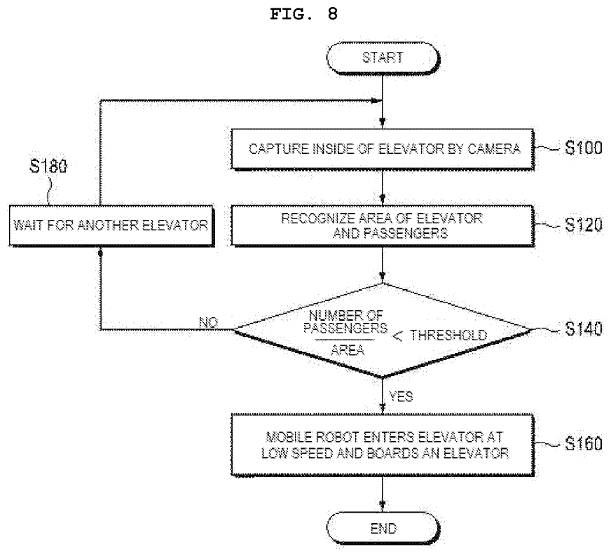

Hereinafter, operations of preferred embodiments will be described in detail with reference to the accompanying drawings. First, FIG. 8 is a flowchart illustrating an operation method for the mobile robot according to the embodiment of the present invention. As illustrated in FIG. 8, first, the camera 120 captures the inside of the elevator 10 (S100). FIG. 3 illustrates an example of the image 90 of the elevator 10. The image processing unit 192 deletes a region other than the elevator 10 from the image 90 and converts the image into a JPG file.

Next, the object recognition unit 194 recognizes the area of the elevator 10 and the number of passengers 20 from the image 90 (S120). Specifically, first, the inference unit 196 receives the image 90 and inputs the image into the internal artificial intelligence model to infer the area of the elevator 10 and the number of passengers. By executing a facial recognition algorithm, the object recognition unit 194 recognizes a face-recognized passenger as an object and calculates the number of passengers. Next, the object recognition unit 194 determines the final number of passengers by averaging g both the number of passengers inferred and the number of passengers calculated by a program.

Next, the control unit 110 calculates a density of the elevator 10 based on the area and the number of passengers. The density is calculated as a percentage of (number of passengers/area).

Next, the control unit 110 performs comparison of whether the calculated density (for example, 50%) is lower than a threshold (for example, 65%) (S140). If the density is lower than the threshold, the control unit 110 controls the driving wheel motor 170 and performs boarding of the elevator (S160).

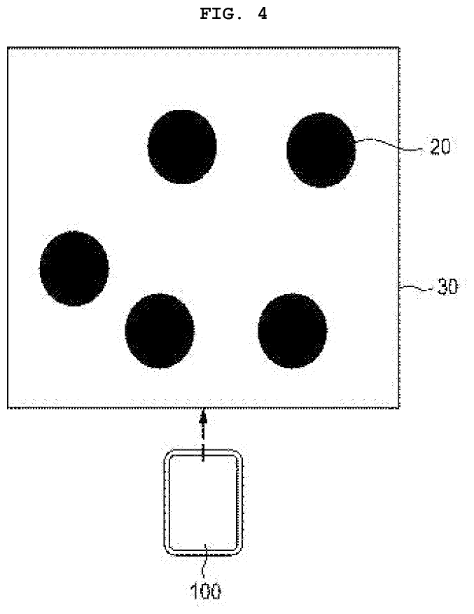

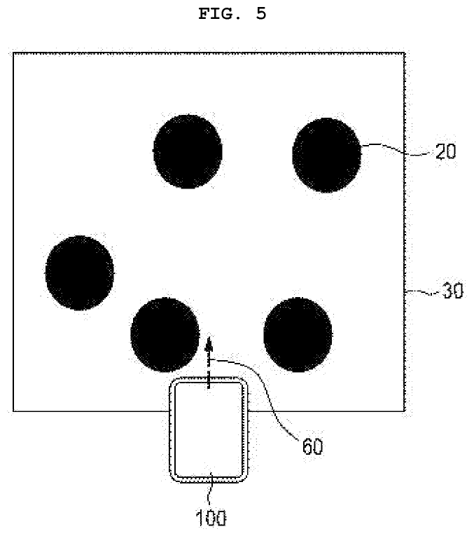

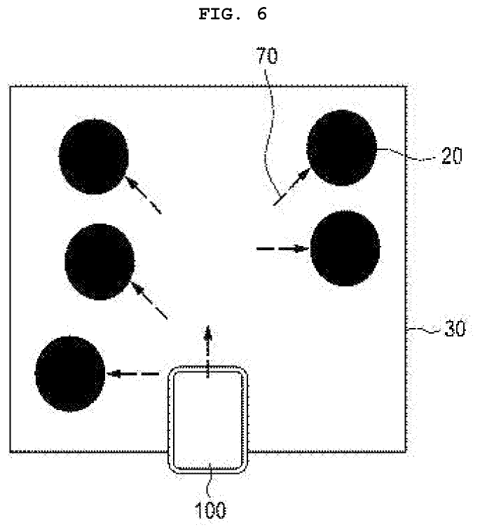

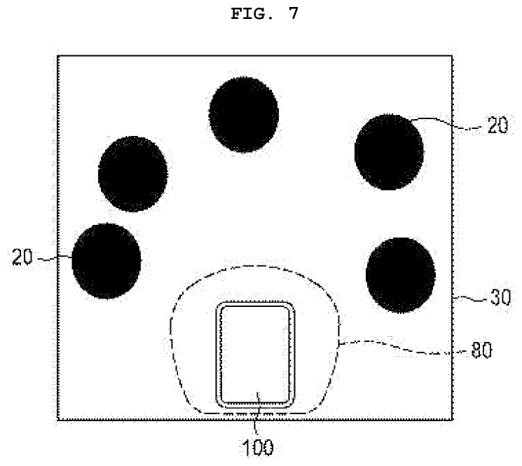

FIGS. 4 to 7 are plan views illustrating, step by step, a process of boarding the elevator by a mobile robot according to the embodiment of the present invention. As illustrated in FIGS. 4 and 7, the mobile robot 100 performs an entry 60 at a low speed, and the passengers move backwards 70 closer to each other.

When the boarding step S160 is executed, the speaker 184 outputs the boarding guidance audio (for example, please, move closer to each other), and the display 182 turns on a warning light to attract attention for the boarding operation or displays a guidance sentence and a guidance animation on an LCD screen.

In addition, in the boarding step S160, the mobile robot 100 boards the elevator at a low speed (for example, 1 to 2 km/h) slower than the walking speed of the passenger 20 and stops by designating, as a boarding position 80, a region adjacent to a door of the elevator 10. At this time, the boarding position 80 is prepared while the passengers 10 on board moves backwards closer to each other.

If, in the comparing S140, the density (for example, 70%) is equal to or higher than the threshold (for example, 65%), the mobile robot 100 does not board the elevator 10 but waits for another elevator 10 (S180).

The detailed descriptions of preferred embodiments of the present invention disclosed as described above have been provided such that it is possible for those skilled in the art to implement and realize the present invention. Although the descriptions have been provided with reference to the desirable embodiments of the present invention, it will be understood that those skilled in the art can variously modify and change the present invention within a range without departing from the scope of the present invention. For example, those skilled in the art can use each of the configurations described in the above-described embodiments in a way of combining the configurations with each other. Hence, the present invention is not intended to be limited to the embodiments illustrated herein, but to provide a maximum range consistent with the principles and novel features disclosed herein.

The present invention can be embodied into another specific example within a range without departing from the idea and the essential feature of the present invention. Hence, the detailed descriptions are not to be construed to be limited in any aspects but is considered as an exemplary example. The scope of the present invention is determined through reasonable interpretation of the accompanying claims, and any modifications within an equivalent scope of the present invention are included in the scope of the present invention. The present invention is not to be limited to the embodiments illustrated herein, but to provide a maximum range consistent with the principles and novel features disclosed herein. In addition, any claims that do not have an explicit dependent relationship in the claims can be combined to configure an embodiment or be included as new claims by amendment after filing the application.

The mobile robot can determine whether to board an elevator by recognizing an area of the elevator and the number of passengers. Hence, the mobile robot can move quickly between floors by taking the elevator while preventing safety accidents with passengers.

1. A mobile robot for determining whether to board an elevator, the mobile robot comprising:
a camera configured for capturing an inside of the elevator;
an object recognition unit configured for recognizing an area of the elevator and the number of passengers from an image captured by the camera; and
a control unit configured for calculating a density of the elevator based on the area and the number of passengers,
wherein the control unit is configured to perform a determination of whether to board the elevator based on the density, and
the control unit controls is configured to control a driving wheel motor based on the determination.

2. The mobile robot according to claim 1, wherein the camera is a stereo camera.

3. The mobile robot according to claim 1, further comprising:
an inference unit machine-learned to infer the area of the elevator and the number of passengers from a plurality of images,
wherein the object recognition unit is configured to count the number of the passengers based on the inference result and facial recognition of the passengers.

4. The mobile robot according to claim 1, wherein the density is calculated as a percentage of the number of passengers to the area.

5. The mobile robot according to claim 1, further comprising:
at least one of a speaker configured for outputting a guidance audio during boarding the elevator; and a display for attracting attention to a boarding motion.

6. The mobile robot according to claim 1, further comprising:
a loading unit in which a cargo to be delivered is loaded.

7. An operation method for the mobile robot according to claim 1, the operation method comprising:
a capturing step in which a camera captures an inside of the elevator;
a recognizing step in which an object recognition unit recognizes an area of the elevator and the number of passengers from an image captured by the camera;
a comparing step in which a control unit calculates a density of the elevator on the basis of the area and the number of passengers and compares whether the density is less than a threshold; and
a boarding step in which the control unit controls a driving wheel motor to allow boarding of the elevator if the density is less than the threshold.

8. The operation method according to claim 7, wherein, after the comparing step, in a case where the density is equal to or higher than the threshold, a waiting step in which the mobile robot waits for another elevator without boarding the elevator is executed.

9. The operation method according to claim 7, wherein, when the boarding step is executed, at least one of outputting a boarding guidance audio to a speaker and emitting light by a display to attract attention for a boarding motion is executed.

10. The operation method according to claim 7, wherein, in the boarding step, the mobile robot boards the elevator at a low speed slower than a walking speed of the passengers, and stops at a boarding position adjacent to a door of the elevator.

11. The operation method according to claim 7, wherein the recognizing step further includes:
a step in which the inference unit learned by artificial intelligence infers the area of the elevator and the number of passengers from the image, and the object recognition unit recognizes the area of the elevator and the number of passengers, based on the inference result.
